(19) United States
(12) Patent Application Publication
(10) Pub. No.: US 2008/0238929 A1
(43) Pub. Date: Oct. 2, 2008

(54) Local Themeing Of Remote Applications

(76) Inventors: Nadim Abdo, Bellevue, WA (US); Ivan Brugiolo, Redmond, WA (US); Leonardo Blanco, Redmond, WA (US)

Correspondence Address: Emmanuel A. Rivera;Lee & Hayes, PLLC, Suite 500, 421 W. Riverside Avenue, Spokane, WA, 99201, US

(21) Appl. No.: 11/694,611

(22) Filed: Mar. 30, 2007

(51) Int. Cl. G09G 5/00

(52) U.S. Cl. 345/581

(57) ABSTRACT

Methods and systems for local themeing of remote applications is disclosed. In an implementation, a redirection surface is defined by a server corresponding to a remote application executed by a client. The client sends to the server, a set of theme metrics and parts corresponding to the client and non-client area in the redirection surface. The server utilizes the theme metrics to render the contents of part of the redirection surface. The rendered contents are utilized by the client to re-render the client area of the redirection surface. The non-client area is rendered locally at the client based on local client theme settings.

### BACKGROUND

In most cases, it is preferable for computer users to use an operating system that supports state-of-the-art graphics capabilities. For example, many operating systems may have components responsible for providing common visual looks or themes for one or more application windows. A “theme” may be specific to an operating system, and may be modified by a user of the operating system. In typical server-client architectures, a client computing device or client may access and execute a remote application hosted on a server computing device or server. An application window or proxy window may be displayed at the client corresponding to the remote application being executed at the server. Certain portions of the proxy window may correspond to an area. The visual looks or theme of such portions of the proxy window, are not under direct control of the remote application. A designated component of an operating system may take care of the visual aspects of such a non-client area.

In many current implementations, contents of the proxy window are rendered at the server and sent to the client for displaying. Accordingly, the proxy window at the client corresponds to a server-theme (i.e., theme settings at the server) and may be different from a client-theme (i.e., theme settings at the client). Therefore, there is a lack of seamlessness integration of the remote applications with local applications at the client. Furthermore, certain new themes may not be supported in the server-client architecture due to one or more characteristic features of the themes. For example, a theme may have transparent elements and may not be correctly rendered on the server for a remote application, because the theme may require transparency to show through to local content or background (i.e., at the client) which is not available at the server. Furthermore, the server may not be able to render an application window which is in exact conformance with client theme settings.

### SUMMARY

This summary is provided to introduce simplified concepts of local themeing of remote applications, which is further described below in the Detailed Description. This summary is not intended to identify essential features of the claimed subject matter, nor is it intended for use in determining the scope of the claimed subject matter.

Method of local themeing of remote applications is described. In one implementation, the method includes creating a redirection surface, receiving local theme metrics that support the redirection surface, and rendering the redirection surface based on the local theme metrics. Furthermore, a proxy window may be rendered corresponding to the remote application using rendered contents of the redirection surface and the local theme metrics.

### BRIEF DESCRIPTION OF THE DRAWINGS

The detailed description is described with reference to the accompanying figures. In the figures, the left-most digit(s) of a reference number identifies the figure in which the reference number first appears. The use of the same reference number in different figures indicates similar or identical items.

FIG. 1 is an illustration of an exemplary system implementing local themeing of remote applications according to an embodiment.

FIG. 2 is an implementation of an exemplary server computing device for implementing local themeing of remote applications.

FIG. 3 is an implementation of a client computing device to facilitate local themeing of remote applications.

FIG. 4 shows an exemplary visual tree generated for local themeing of remote applications.

FIG. 5 illustrates a series of exemplary interactions between a server computing device and a client computing device for implementing local themeing of remote applications according to an embodiment.

FIG. 6 shows an exemplary method for local themeing of remote applications according to an embodiment.

### DETAILED DESCRIPTION

The following disclosure describes systems and methods for local themeing of remote applications. While aspects of described systems and methods for local themeing of remote applications can be implemented in any number of different computing systems, environments, and/or configurations, embodiments of the systems and methods are described in context of the following exemplary system architecture(s).

Typical server-client computing environments enable a client computing device or client to access and execute remote applications hosted on a server computing device or server. Upon execution of the remote application, an application window is rendered for displaying on a display device, such as a monitor at the client end. Each such application window has an associated visual theme which dictates the presentation of parts of the application window. The application window may be divided into two regions/areas: a client area and a non-client area. A non-client area corresponds to a portion of an application window, the visual theme of which is not directly controlled by the application. The visual theme of a non-client area of a proxy window at the client corresponds to a server-theme, and may be different from a local client-theme. It may be desirable to enable seamless integration of the remote application with a local application hosted at the client by implementing the same theme and providing full access to same features, such as a local preview thumbnail, at the client. A client area corresponds to a portion of an application window that may host standard controls, like push buttons, check-boxes, list-boxes. The visual theme of standard controls is not directly controlled by the application. The visual theme of standard controls in the client area corresponds to the server theme, and may be different from a local theme. It may be desirable to enable seamless integration of the remote application with a local application hosted at the client by implementing the same theme for standard controls.

Systems and methods are disclosed for local themeing of remote applications. To this end, the systems and methods describe a mechanism to implement local rendering of the non-client area of a proxy window corresponding to the remote application, and a mechanism to render the common controls of the client area in conformance with the local theme. In an implementation, the mechanism involves redirecting from the client to the server, a set of theme metrics (e.g., frame dimensions) and theme parts (e.g.: image to be drawn as the background of a default push button) associated with the proxy window. The server receives the theme metrics and parts and renders the proxy window with minimal or no server-theme in the non-client area, based on the theme metrics. The server uses the received theme metrics and theme parts to draw common controls of the client area in conformance with the client theme. The client renders the non-client area of the remote application based on the local theme settings and utilizes the rendered information from the server to display the proxy window. The proxy window displayed at the client has the same theme (i.e. client theme) as for the local applications (hosted at the client) thereby giving a uniform visual look. In contrast to the prior art systems and methods, the disclosed mechanism enables an implementation of any new theme (at the client) onto a non-client area of a remote application independent of the server theme. The disclosed mechanism also enables an implementation of any new theme (at the client) onto the common controls inside the client area of a remote application independent of the server theme.

### Exemplary System

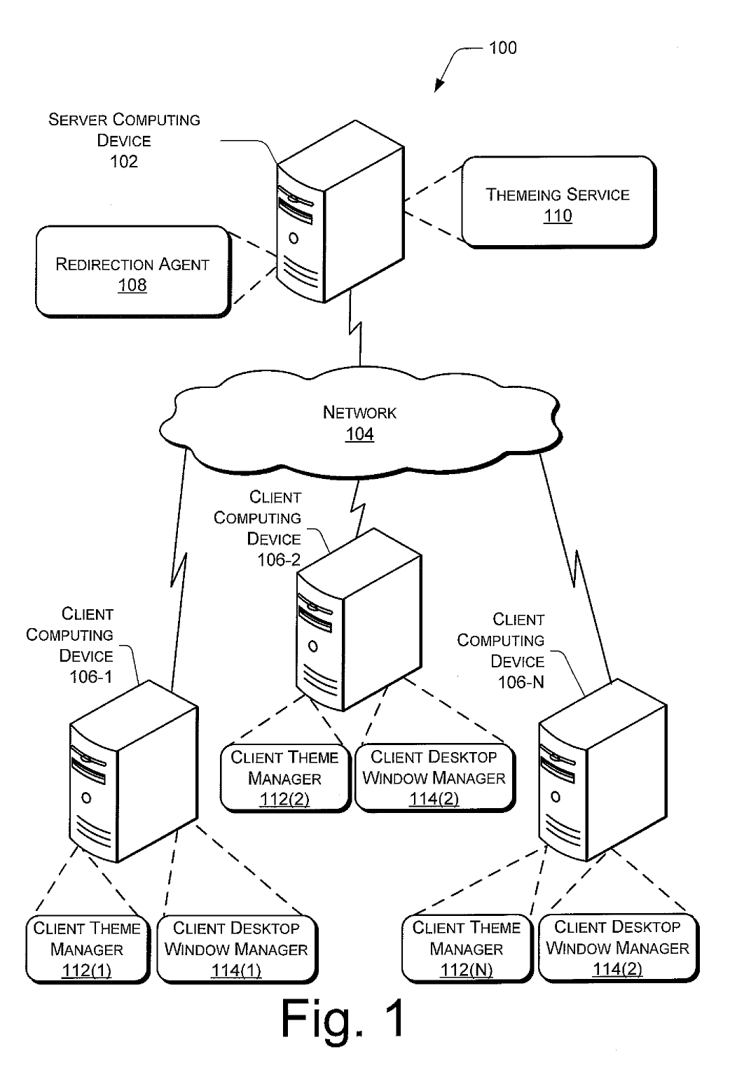

FIG. 1 shows an exemplary remote client access system 100 for local themeing of remote applications. To this end, the system 100 includes a server computing device or server 102, communicating through a network 104, with one or more client computing devices or clients 106-1, 106-2, 106-N. The system 100 may be a Terminal Services™ system as provided or defined by Microsoft® Corporation, where the multiple clients 106 rely on applications which execute on the server 102.

The server computing device 102 may be implemented with an operating system (e.g., Windows® Server 2003 operating system) provided by the Microsoft® Corporation. The server 102 and the clients 106 may implement a communication protocol such as remote desktop protocol (RDP), in order to pass data or information (i.e., communicate) with one another. The use of such communication protocols, and particularly RDP, may be implemented in the context of a remote client access system such as a Terminal Services™ system.

The server 102 may be implemented as any of a variety of conventional computing devices, including, for example, a desktop PC, a notebook or portable computer, a workstation, a mainframe computer, a mobile computing device, an entertainment device, a game console, a set-top box, a DVD player, an Internet appliance, etc. The server 102 may also include one or more of the aforementioned conventional computing devices configured as a server in a server-client computing environment.

The clients 106 may be a general-purpose PC (personal computer), a laptop PC, a tablet PC, or the like, and may implement an operating system such as a Windows® brand operating system from Microsoft® Corporation. The clients 106 may be a standalone computer that primarily interfaces to server 102 to access files or other information (e.g., application programs resident at the server 102) that are not locally stored at client 106.

The network 104 may be a wireless or a wired network, or a combination thereof. The network 104 may also be a collection of individual networks, interconnected with each other and functioning as a single large network (e.g., the Internet or an intranet). Examples of such individual networks include, but are not limited to, Local Area Networks (LANs), Wide Area Networks (WANs), and Metropolitan Area Networks (MANs). Moreover, the network 104 connecting the server 102 and clients 106 may implement a transport protocol such as transmission control protocol over Internet protocol (TCP/IP).

The system and methods disclosed herein implement local themeing of remote applications. A theme refers to a collection or set of appearance characteristics relating to an application. Typically, a remote application often requires control of graphical components to be rendered, or displayed on a monitor, etc. at the client end. For example, an application may need to display one or more components of the non-client area such as a caption bar, a system manual, state buttons (e.g., minimize, maximize, restore, etc.), system icons etc. For example, an application may need to display one or more standard controls of the client area, such as push buttons, check-boxes, radio-button, etc. Accordingly, themeing includes providing a common visual look to different application windows by controlling rasterizing and rendering aspects associated with the applications. A designated component (e.g., a desktop window manager compositor) of an operating system provides for rasterizing and rendering capabilities for displaying an application window.

In an exemplary implementation, clients 106 access and execute one or more remote applications hosted on the server 102. Upon execution of such a remote application, a client 106 and the server 102 participate in a client-server session initiated between the two. The client-server session provides for an application window (e.g., proxy window) at the client 106 corresponding to a particular remote application.

A redirection agent 108 at the server 102 creates a redirection surface for each top-level application window. Top-level windows refer to a set of application windows arranged according to an order commonly referred to as “z-order”. The client 106 utilizes the redirection surface created by the server 102 to render a proxy to the application window. It may be noted that a “proxy window” may be a “remote application integrated locally” or RAIL window. Each such application window may be divided into two regions: 1) a client area, and 2) a non-client area. The two regions differ based on the control in which a corresponding remote application exercises over the regions. Accordingly, a client-area refers to a region which is under a direct control of the remote application. A non-client area refers to a region which is not under a direct control of the remote application. The server 102 implements a themeing service 110 to facilitate local rendering of non-client area of the proxy window at the client 106, and remote rendering of themed windows parts belonging to the client area of the proxy window.

The themeing service 110 may be a component of a server operating system which provides for rasterizing and rendering capabilities at the server 102. The redirection agent 108 renders and redirects contents of a remote application to clients 106 for display. Clients 106 include a client theme manager 112, as illustrated respectively by client theme managers 112(1), 112(2), . . . , 112(N). Client desktop window managers 114(1), 114(2), . . . , 114(N) utilize the rendered contents of the remote application for presenting a proxy window at a client 106.

The local themeing of remote application may implement a mechanism for querying the client theme manager 112 for a set of theme metrics (e.g., theme metric dimensions, frame size, etc.) and theme parts (e.g. the image of a checked check-box) corresponding to the remote application. The client theme manager 110, in response to the query, provides the theme metrics and the theme parts which are redirected to the server 102. The server 102 utilizes the theme metrics to render the contents of the remote application window (i.e., proxy window) at the server 102. In an implementation, the server 102 implements a no server-theme or minimal theme while rendering the non-client area of the window. In an implementation, the server 102 implements a full theme with client metrics and parts while rendering common controls in the client area of the window.

The client 106 receives the rendered contents of the window onto the proxy window, along with server theme metrics and clipping information for the proxy window. Subsequently, the client 106 presents the client area of the remote application onto the proxy window. The client theme manager 112 renders non-client area utilizing the local client theme settings thereby giving the proxy window a look defined by a client theme settings. Accordingly, the non-client area is locally rendered at the client 106 and the client area is rendered at the server 102. The client theme manager 112 provides theme metrics and parts to the remote theme manager. The remote theme manager has rendered the client area according to the client theme. Such a rendering mechanism results in a seamless integration of remote applications with the local applications that are hosted at the client 106.

### Exemplary Server Computing Device

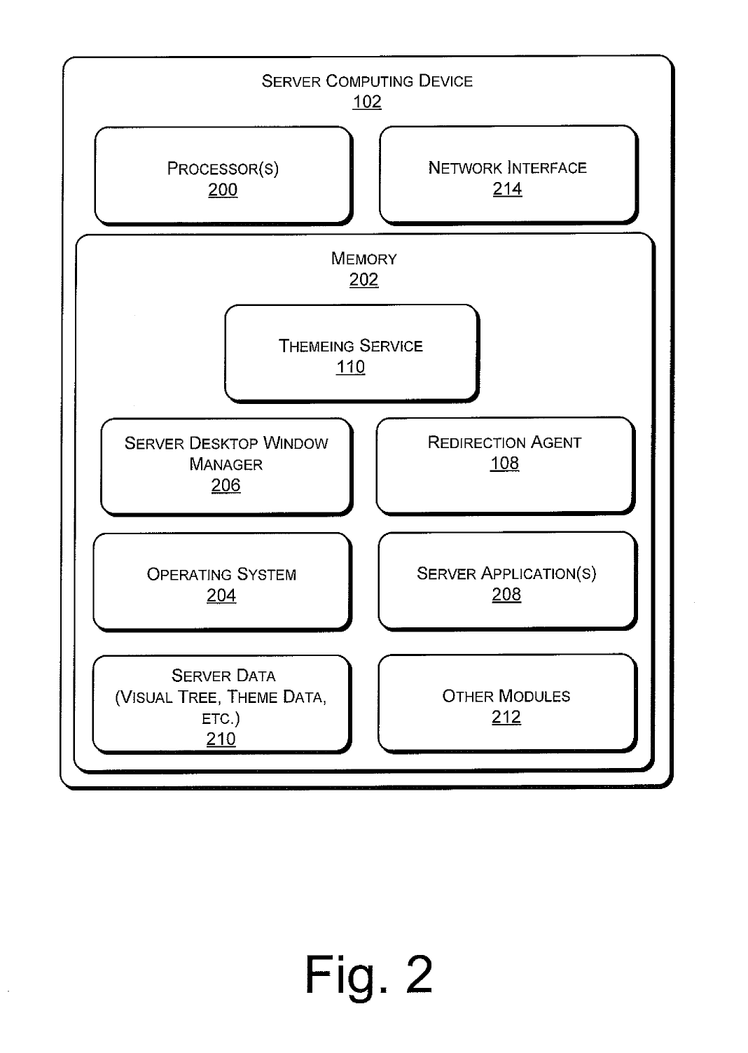

FIG. 2 shows an implementation of the server computing device (server) 102 for local themeing of remote applications. To this end, the server computing device 102 includes one or more processor(s) 200 coupled to a memory 202. Processor(s) 200 could be, for example, microprocessors, microcomputers, microcontrollers, digital signal processors, central processing units, state machines, logic circuitries, and/or any devices that manipulate data based on operational instructions. Processor(s) 200 are configured to fetch and execute computer-program instructions stored in the memory 202. Memory 202 includes computer-readable media in the form of volatile memory, such as Random Access Memory (RAM) and/or non-volatile memory, such as Read Only Memory (ROM) or flash RAM or a combination thereof.

The memory 202 includes an operating system 204 that provides a platform for execution of one or more remote applications on the server 102. In typical server-client architecture, the server 102 functions as an application server where the clients 106 rely on applications which execute on the server 102. Such applications provide for all or certain application programs that provide functionality, and particularly access and control of one or more remote applications.

The memory 202 further includes a server desktop window manager 206 and the themeing service 110. The server desktop window manager 206 is responsible for presentation at the display of application windows when a remote application is executed at the server 102. The remote applications include server application 208 which executes at the server when a clients 106 instantiates a server-client session. The themeing service 110 enables the functionality of mandating uniform visual appearance for the common controls of the client and non-client area region of a window. The server application 208 may be applications included in Microsoft® Office 2007 suite.

In an exemplary implementation, the server 102 runs in a redirection mode for application using graphics device interface (GDI) drawing commands. Graphics Device Interface (GDI) is an application programming interface and it interface the applications with one of the components for representing graphical objects and transmitting the graphical objects to output devices such as monitors and printers. In a GDI redirection mode, the server 102 carries out rasterizing and rendering of contents of an application window corresponding to an application and redirects the rendered contents to an intermediate surface. In an implementation, the rasterization process for the redirection surface can be sent over the network and re-created at the clients 106.

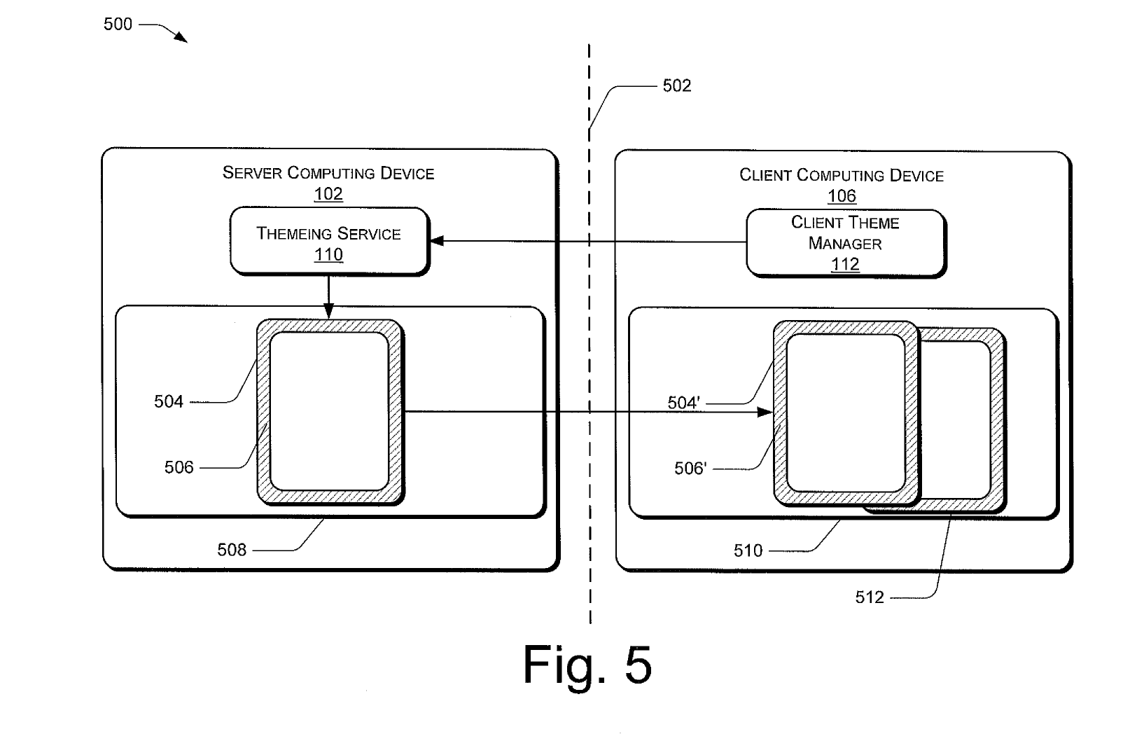

Accordingly, when a client 106 accesses the server 102 and executes a server application 208, a proxy window or RAIL window is implemented at the client 106. The server 102 creates a redirection surface which may also be referred to as a “sprite”, and corresponds to the application window to be rendered. It may be appreciated that a redirection surface or sprite is a part of a frame buffer utilized by the server 102 for rendering the application window corresponding to the server application 208. An illustration of the redirection surface is shown in FIG. 5 and will be explained in detail under the section titled “Exemplary Methods.”

As soon as the client 106 initiates the execution of the server application 208, the server 102 notifies the client 106 about the RAIL window implementation. The server 102 indicates to the client 106 that the rendering of the top-level windows or application windows are performed utilizing the redirection surface defined by the server 102 in the GDI redirection mode. In a successive progression, the client theme manager 112 is queried for a set of theme metrics and theme parts. The theme metrics include, for example, dimensions of the non-client area, window frame size and similar attributes that characterize the presentation and structure of the non-client area of the proxy window at the clients 106. The theme parts include, for example, the image used to represent a check check-box button, or the default background of a pushed button. In one of the configurations, the theme metrics enable matching of the dimensions of the frame of the window. In one implementation, the theme parts allow matching of the client area part between the client and the server. The clients 106 send the theme metrics and parts to the themeing service 108.

The server 102 receives and stores the theme metrics and theme parts in server data 210. The server data 210 may also store the server theme settings and other similar information which may be utilized for rasterizing and rendering functions of the server 102. The themeing service 110 utilizes the received theme metrics to render the redirection surface with a no server-theme or minimal GDI-theme for the non-client area. The themeing service 110 utilizes the theme parts to render the common parts of a window in the client area. This ensures that there is no duplication of themeing of the non-client area at the server 102 and the clients 106.

Subsequently, a proxy window or RAIL window is created corresponding to the remote server application 206 at the client 106 with adequate attributes and style in accordance with the server theme. The client 106 utilizes clipping information and the server theme settings received from the server 102 to display the client-area onto the RAIL window. The non-client area is rendered by the client theme manager 110 automatically to completely display the proxy window or RAIL window. Furthermore, the memory 202 includes other modules 212 to generate and store data structures for implementing local themeing of remote applications. It may be appreciated that a client-server server may exist between the client 106 and the server 102 and accordingly the other modules 212 may also include a remote session module to create the client-server session. In addition, the server 102 also includes a network interface 214 to establish communication with the one or more clients 106.

### Exemplary Client Computing Device

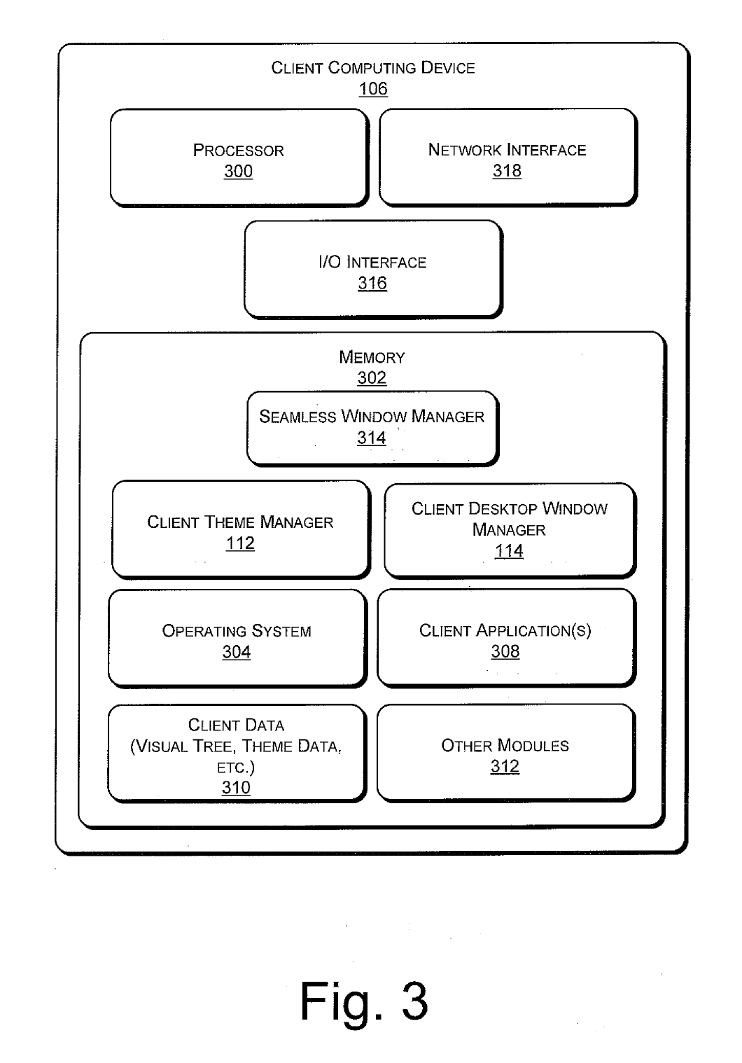

FIG. 3 shows an implementation of the client computing device or client 106 for local themeing of remote applications. To this end, the client 106 includes one or more processors 300 coupled to a memory 302. Such processor(s) 300 could be for example, microprocessors, microcomputers, microcontrollers, digital signal processors, central processing units, state machines, logic circuitries, and/or any devices that manipulate data based on operational instructions. Processor(s) 300 are configured to fetch and execute computer-program instructions stored in the memory 302. Memory 302 includes computer-readable media in the form of volatile memory, such as Random Access Memory (RAM) and/or non-volatile memory, such as Read Only Memory (ROM) or flash RAM or a combination thereof.

The memory 302 may include an operating system 304 that provides a platform for execution of one or more client applications on the client 106. The operating system may be one of various Microsoft® operating systems. The memory 202 further includes a client desktop window manager 306 and the client theme manager 110. The client desktop window manager 306 is responsible for presentation at the visualization device, such as a display or monitor, of an application window at the client 106.

In an alternative implementation, the client desktop window manager 306 may include a desktop compositing engine or DCE. Client desktop window manager 306 may create a number of on-screen effects. The on-screen effects include translucent window borders which show parts of window content lying beneath and a stacking effect displayed when users switch between applications. Although the client desktop window manager 306 is shown as a separate block, it may be appreciated that it may be included in the operating system 304.

A proxy window at the client 106 may also be a RAIL application window for remote server applications 208. As discussed above, the server 102 creates a redirection surface or sprite which corresponds to a portion of frame buffer that contains a rendered application window. Exemplary frame buffers at the server 102 and the client 106 are shown in FIG. 5 for illustration purposes. The memory 302 also includes client applications 308 which may be locally executed and rendered by the client desktop window manager 306.

In an exemplary implementation, a client 106 initiates the execution of the server application 208 upon which the server 102 notifies the client 106 about the RAIL window implementation. Subsequently, the client desktop window manager 306 queries the client theme manager 110 for a set of theme metrics and theme parts. In an implementation, these theme metrics can be the transparency level for the glass effects, the color of state button, and such.

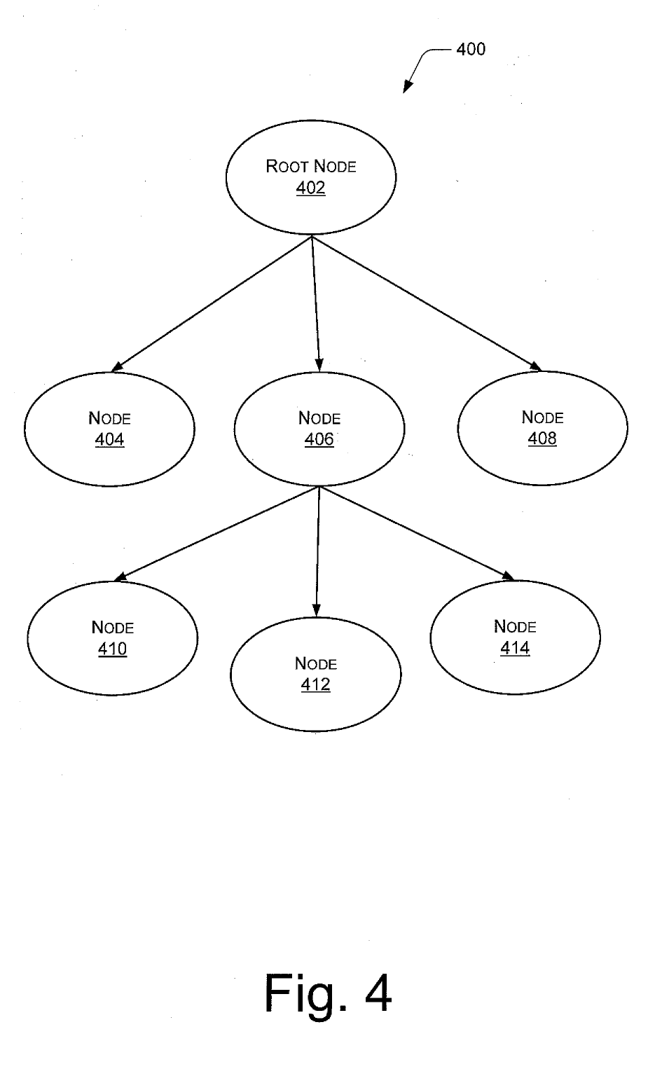

The client desktop window manager 306 may also generate and maintain a data structure (e.g., a visual tree) that represents structural and presentation information of certain class of applications (e.g., server application 208, client application 308). In such a case, the structural and presentation may be obtained from a data structure or a visual tree corresponding to the remote application. The theme metrics or the visual tree may be stored in client data 310. The client theme manager 110 sends the theme metrics and theme parts to the server 102. The theming service 110 running at the server receives those metrics and makes them available for the applications and components running at the server. For example, a desktop window manager included in an operating system, may implement a visual tree to represent a structure and presentation information of windows presentation foundation or WPF applications. Such a visual tree has been shown in FIG. 4 and is further discussed herein under the section entitled “Exemplary Visual Tree.”

The themeing service 110 receives the set of theme metrics and theme parts. The theming service 110 renders a no server-theme or minimal GDI theme, for the non-client area of the remote server application 208, and it fully renders the common controls of the client area, such as buttons, check-boxes, etc. The server 102 sends the rendered contents of the server application window along with render information to the client 106. The render information may include clipping information, z-order information, etc. The client 106 receives and utilizes the rendered contents and the render information to render the client area onto a corresponding proxy window or RAIL window. The non-client area is rendered automatically by the client theme manager 110.

Memory 302 may include a seamless window manager 314 that communicates and receives rendered contents of an application window from the desktop window manager 102. In an implementation, the client seamless window manager 314 receives the rendered contents of a redirection surface and re-renders a client area onto a proxy window.

The memory 302 may further include other modules that facilitate the initiation of a client-server session when the client 106 executes a server application 208. The client 106 also includes an input output (I/O) interface 316 to enable a user of the client to set or modify client theme settings. Such modification of client theme settings may include settings of a new theme which may be applied to the non-client area of the proxy or RAIL window at the client 106 corresponding to the remote server application 208.

The client theme manager 112 may notify the server 102 about modifications in the client theme metrics and theme parts (e.g., frame window dimensions, color for the background of a default button etc.). The server 102, on receipt of such a notification, re-renders the contents of the application window with minimal GDI or no server theme with regard of the non-client area, and with full theme with regard of the common controls of the client area, based on the modified theme metrics and sends the rendered contents to the client 106. Accordingly, the client 106 receives and utilizes the last rendered contents from the server along with other render information to display the client area of the proxy or RAIL window. The non-client area is rendered in accordance with the current local theme settings at the client, thereby giving a uniform look to both client and server application windows at the client 106. Furthermore, the client 106 also includes a network interface 318 to establish communication with the server 102.

### Exemplary Visual Tree

FIG. 4 illustrates an exemplary visual tree 400 according to an implementation. Accordingly, the client desktop window manager 306 implements a visual tree 400 to represent presentation and structural information of an application (e.g., client application 308). In such an implementation, the client desktop window manager 306 maintains one or more top level windows corresponding to one or client applications 308, each of which is associated with a set of attributes or properties. The attributes may include clipping, visibility, custom non-client area, thumbnail representation, flip 3-D behavior, etc. The client desktop window manager 306 generates a visual tree 400 for each of the top level windows. A typical visual tree has a number of nodes where each node may represent presentation and structure information for non-client area, system icons, state buttons, client area, etc.

The visual tree 400 has a root node 402 specifying an application type or a class. The root node 402 has child nodes 404, 406, and 408. Node 404 corresponds to information about a non-client area of an application. Node 408 corresponds to information about client area of an application. Node 406 includes information about other parts of the non-client area of the application. For example, the node 406 has child nodes 410, 412, and 414. The node 410 represents information about system icons in an application window. Similarly, the nodes 412 and 414 correspond to state buttons and caption bar in the application window. The visual tree may also include another node for blurring feature of an application. Blur is a feature which may be included in an operating system, in which the background area of an application window is blurred and the application window has a translucency associated with it. In an implementation, the client desktop window manager 306 represents the client theme visual appearance (influenced by the theme metrics) in the form of one or more nodes in the visual tree 400.

In an exemplary embodiment, the client desktop window manager 306 evaluates the attributes or properties of a window (or proxy window) to create a visual tree representing how to render the non-client area parts, and how to position the client area. The client desktop window manager walks through a list of top level windows to generate a visual tree corresponding to a client application 308. For example, a top level window may not have the flip-3D behavior in which different application windows may be viewed in a perspective view. Therefore, the client desktop window manager 306 does not see the application in 3-D, because the application window has elected not to be in such a representation. Hence, the client desktop window manager 306 implements various views of the window list utilizing the concept of visual tree. It may be appreciated that a similar visual tree 400 may also be implemented by the server desktop window manager 206 corresponding to the server application 208.

### Exemplary Method

An exemplary method for local themeing of remote applications is described with reference to FIGS. 1 to 4 and FIG. 5 in particular. FIG. 5 shows a series of exemplary interactions between the server 102 and the client 106 for implementing local themeing of remote applications. The exemplary method may be described in the general context of computer executable instructions. Generally, computer executable instructions can include routines, programs, objects, components, data structures, procedures, modules, functions, and the like that perform particular functions or implement particular abstract data types. The methods may also be practiced in a distributed computing environment where functions are performed by remote processing devices that are linked through a communications network. In a distributed computing environment, computer executable instructions may be located in both local and remote computer storage media, including memory storage devices.

In FIG. 5, the server 102 and the client 106 interact through a server client interface 502. The server 102 includes the themeing service 108 to render an application window 504 corresponding to the server application 208. As discussed above, the application window 504 has a non-client area 506 to which a server-theme may be applied while rendering at the server 102. The themeing service 108 utilizes a server frame buffer 508 to render the application window 504. The application window 504 has a client area, and, the theming service uses a frame buffer to render the common parts of a window, such as the default buttons, check-boxes, etc.

Subsequent to the defining of the redirection surface, the redirection agent 211 sends a notification to the client computing device to utilize the redirection surface for rendering of the proxy application window. As shown in FIG. 5, the client 106 includes the client theme manager 112 to render a proxy application window 504′ (corresponding to the application window 504). FIG. 5 also shows the non-client area 506′ of the proxy window 504′. The client computing device 106 renders the proxy window 504′ onto a client frame buffer 510. The client frame buffer 510 may also includes another application window 512 which may correspond to a local client application 308. Both the proxy window 504′ and the application window 512 have respective non-client areas (shown as hatched regions). The systems and methods described herein seamlessly integrate the proxy window 504′ and the application window 512 by giving them a same visual look.

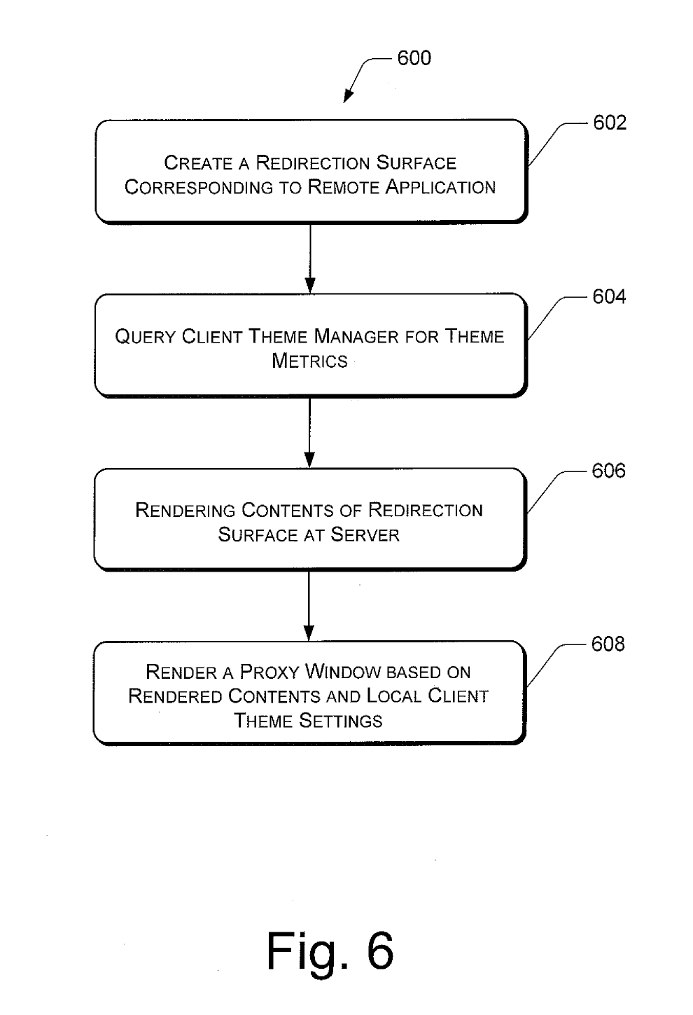

FIG. 6 illustrates an exemplary method 600 for local themeing of remote applications. The order in which the method is described is not intended to be construed as a limitation, and any number of the described method blocks can be combined in any order to implement the method, or an alternative method. Additionally, individual blocks may be deleted from the method without departing from the spirit and scope of the subject matter described herein. Furthermore, the method can be implemented in any suitable hardware, software, firmware, or combination thereof.

At block 602, a redirection surface is created at a server corresponding to a remote application whose execution is initiated by a client (e.g., client 106). In an implementation, the server 102 defines a redirection surface which corresponds to the server application window. The redirection surface refers to a portion of a server frame buffer 508 as in FIG. 5, which would contain the application window when rendered by the theming service 110 and by the application itself.

At block 604, a client theme manager 110 is queried for local theme settings (e.g., client theme metrics and theme parts). In particular, the client desktop window manager 306 queries the client theme manager 120 for client theme settings. Theme settings may include theme metrics like, dimensions of non-client areas, shape, size, etc. of the non client area, blurring technique, etc. This prevents a duplication of themes at the server 102 and the client 106 for the proxy window 504′. In response to the query, the client theme manager 112 sends the theme metrics to the server themeing service 110. As discussed earlier, the theme metrics include the dimensions of the frame 504 for any window. The client desktop window manager 114 generates and utilizes a visual tree to represent presentation and structural information for the application windows rendered at the client frame buffer 510. In such an embodiment, the client theme manager 110 provides the theme metrics used to set attributes to one or more nodes of a visual tree.

At block 606, contents of the redirection surface are rendered at the server based on the client theme metrics. The themeing service 108 receives and utilizes the theme metrics and theme parts from the client theme manager 110 and renders the contents of the redirection surface with no server-theme or minimal GDI-theme for the non-client area and with full GDI-theme for the client area common parts. The themeing service 108 utilizes the theme metrics and theme parts to render a no-theme non-client area and utilizes theme parts to render the common controls in the client area of the application window 504.

As shown in FIG. 5, the non-client area 506 corresponds to a no server-theme or minimal GDI theme. The client area as shown in the un-hatched portion of the application window 504, is rendered utilizing the theme metrics and parts coming from the client. It may be appreciated that when an application (e.g., server application 208, client application 308, etc.) is executed, the desktop window manager (e.g. client desktop window manager 306, server desktop window manager 206) is called upon by the application to perform the final render to screen of the contents of a corresponding application window.

The execution instruction required for rendering the application window may be stored in a dynamically linked library (DLL) accessed by the desktop window manager or by the application. A set of parameters (exposed by the DLL after calling into the theming service) which dictate the presentation of client-area, is referred to as system metrics; the non-client area is governed by theme settings (e.g. theme metrics and theme parts), that override the system metrics in conformance with the desired visual appearance. The themeing service 108 renders a no server theme for the non-client area 506 and renders the common parts in the client area in accordance with the currently selected metrics and parts of the server 102. The desktop window manager 206 communicates the rendered contents of the application window 504 to the client Seamless Window Manager 314.

At block 608, the rendered contents of the redirection surface along with local client theme settings are utilized by the client to render a proxy window corresponding to the remote application. In one of the configurations, the client Seamless Window Manager 314 receives the rendered contents of the redirection surface and re-renders the client area onto the proxy window 504′ as shown as an un-hatched region in 504′. The non-client area 506′ is locally rendered onto the client frame buffer 510 based on client theme settings. In an alternative embodiment, the local client theme settings may be modified by a user of the client 106. In such an embodiment, a corresponding change in theme metrics and theme parts (e.g., dimensions of the frame of window, dimensions of non-client area, etc.) at the client 106 is communicated to the server 102. Such a communication occurs as a global event like synchronization of time, etc. The server 102 accommodates such modifications by rendering the redirection surface once again, based on the modified theme metrics as at block 606.

### CONCLUSION

The above-described methods and systems describe local themeing of remote applications. Although the invention has been described in language specific to structural features and/or methodological acts, it is to be understood that the invention de fined in the appended claims is not necessarily limited to the specific features or acts described. Rather, the specific features and acts are disclosed as exemplary forms of implementing the claimed invention.

What is claimed is:

1. A server computing device comprising:
a memory;
one or more processors operatively coupled to the memory;
a desktop window manager in the memory; and
a themeing service in the memory, wherein the theming service manages settings used to customize visual appearance of common window parts.

2. The server computing device of claim 1, wherein the server computing device runs in a graphics device interface redirection mode.

3. The server computing device of claim 1, wherein the server computing device creates a redirection surface that corresponds to an application window to be rendered.

4. The server computing device of claim 1, wherein the themeing service receives theme metrics and parts from the remote client device.

5. The server computing device of claim 4, wherein the theme metrics include one or more of the following: dimensions of non-client area, window frame size, background of a default button and similar attributes that characterize presentation and structure of the common parts of the client or non-client area of the window at the computing device.

6. The server computing device of claim 4, wherein the themeing service utilizes the theme metrics and parts to render a redirection surface.

7. The server computing device of claim 1 further comprising a module to generate data structures for implementing a local theme at the remote client computing device.

8. A client computing device comprising:
a memory;
one or more processors operatively coupled to the memory; and
a client desktop window manager in the memory; and
a client theme manager; and
a seamless window manager in the memory for presentation of an application window of a remote application, at the client computing device.

9. The client computing device of claim 8, wherein the client theme manager includes a series of application program interfaces that allow application and components to communicate with the client theme manager.

10. The client computing device of claim 8, wherein the client desktop window manager includes a desktop compositing engine.

11. The client computing device of claim 8, wherein the client desktop window manager may creates one or more on-screen effects.

12. The client computing device of claim 8, wherein the client desktop window manager generates and maintains a data structure that represents structural and presentation information of a certain class of applications.

13. The client computing device of claim 8, wherein the client theme manager notifies a remote server hosting the remote application of modifications in client theme metrics and parts.

14. The client computing device of claim 8 further comprising one or more modules to facilitate a client-server session.

15. A method for local themeing of remote applications comprising:
creating a redirection surface;
querying for local theme metrics to support the redirection surface; and
rendering the redirection surface or parts of it based on the local theme metrics.

16. The method of claim 15, wherein the redirection surface corresponds to a server application window.

17. The method of claim 16, wherein a visual tree represents the server application window.

18. The method of claim 15, wherein the theme metrics and parts are used to render a no-theme non-client area and theme metrics and parts are used to render common parts of a client area of an application window.

19. The method of claim 15, further comprising rendering a proxy window corresponding to the remote application using rendered contents of the redirection surface and the local theme metrics.

20. The method of claim 15, wherein the local theme metrics and parts are modifiable by a user.
